(19) United States
(12) Patent Application Publication
(10) Pub. No.: US 2010/0087250 A1
(43) Pub. Date: Apr. 8, 2010

(54) GPS-Based Method and Apparatus for Playing an Electronic Game, and a Computer Program of the GPS-Based Method

(75) Inventor: Ying-Chen Chiu, Bade City (TW)

Correspondence Address: Vista IP Law Group, LLP, 1885 Lundy Ave., Suite 108, San Jose, CA, 95131, US

(73) Assignee: Ying-Chen Chiu, Bade City (TW)

(21) Appl. No.: 12/361,313

(22) Filed: Jan. 28, 2009

(30) Foreign Application Priority Data
Oct. 3, 2008 (TW) 097138144

(51) Int. Cl. G06F 17/00

(52) U.S. Cl. 463/31; 463/40; 463/43

(57) ABSTRACT

A global positioning system (GPS)-based method for playing an electronic game is disclosed. The method is implemented using a game apparatus that includes a portable electronic device having a GPS receiver. The method includes obtaining location information of the portable electronic device from a satellite signal received through the GPS receiver, and generating a virtual item on the basis of the location information. The virtual item is used by a user to enhance play of the electronic game using the portable electronic device. A GPS-based game apparatus, and a computer program product including a computer-readable storage medium that stores a game program for causing the GPS-based game apparatus to execute steps of the GPS-based method are also disclosed.

### BACKGROUND OF THE INVENTION

1. Field of the Invention

The present invention relates to a global positioning system (GPS) -based method and apparatus for playing an electronic game, and to a computer program product storing a game program of the GPS-based method, in which location information of a portable electronic device is used to generate a virtual item that enhances play of the electronic game.

2. Description of the Related Art

There is a vast array of electronic games that may be played using portable electronic devices. These include online games, mobile games, and handheld video games, as well as virtual pets that are “raised” by a user. However, many such electronic games have a short product lifespan, often quickly losing favor with consumers only a few weeks or months after introduction into the market.

There is a need for an electronic game product that closely associates a user's everyday activities with game play, so that user interest in the electronic game product is maintained for a sustained period of time.

### SUMMARY OF THE INVENTION

Therefore, it is an object of the present invention to provide a global positioning system (GPS)-based method and apparatus for playing an electronic game, and a computer program product storing a game program of the GPS-based method, in which location information of a portable electronic device is used to generate a virtual item that enhances play of the electronic game.

It is another object of the present invention to provide a GPS-based method and apparatus for playing an electronic game, and a computer program product storing a game program of the GPS-based method, in which an electronic coupon that may be redeemed at a physical or web-based retail outlet may be generated, depending on game progress by a user.

The GPS-based method is implemented using a game apparatus that includes a portable electronic device having a GPS receiver, and comprises obtaining location information of the portable electronic device from a satellite signal received through the GPS receiver of the portable electronic device, and generating a virtual item on the basis of the location information. The virtual item is used by a user to enhance play of the electronic game using the portable electronic device. The GPS-based game apparatus comprises: a portable electronic device for providing a user interface to allow a user to play the electronic game; a GPS receiver disposed in the portable electronic device, the GPS receiver receiving a satellite signal and obtaining location information of the portable electronic device from the satellite signal; a generating unit communicatively coupled to the GPS receiver for generating a virtual item on the basis of the location information; and a processor disposed in the portable electronic device and communicatively coupled to the generating unit, the processor performing control to enable play of the electronic game using the portable electronic device by the user, and further performing control such that the virtual item may be used to enhance play of the electronic game.

The computer program product comprises a computer-readable storage medium that stores a game program for causing the GPS-based game apparatus to execute steps of the GPS-based method of this invention.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a GPS-based game apparatus for playing an electronic game according to a first preferred embodiment of the present invention; and

FIG. 2 is a schematic block diagram of a GPS-based game apparatus for playing an electronic game according to a second preferred embodiment of the present invention.

### DETAILED DESCRIPTION OF THE PREFERRED EMBODIMENTS

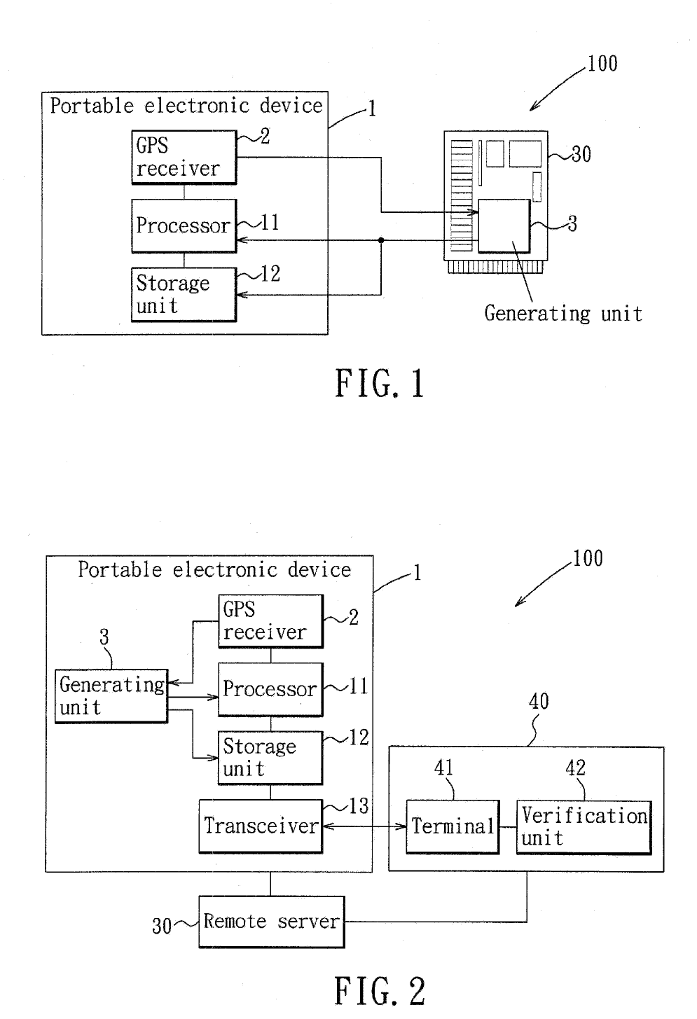

Referring to FIG. 1, a GPS-based game apparatus 100 for playing an electronic game according to a first preferred embodiment of the present invention comprises a portable electronic device 1, a GPS receiver 2, a generating unit 3, a processor 11, and a storage unit 12.

The portable electronic device 1 provides a user interface to allow a user to play the electronic game. The electronic game may be an online game, a mobile game, a handheld video game, or a game related to raising a virtual pet, and the portable electronic device 1 may be a mobile phone, a PDA (personal digital assistant), a PND (personal navigation device), a handheld game console, or any other such device that allows the user to play the electronic game.

The GPS receiver 2 is disposed in the portable electronic device 1 in the first preferred embodiment. However, in other embodiments, the GPS receiver 2 may be disposed on an exterior of the portable electronic device land coupled to component(s) in the latter (i.e., to at least the processor 11). The GPS receiver 2 receives a satellite signal and obtains location information of the portable electronic device 1 from the satellite signal in a known manner. In addition, the GPS receiver 2 uses the location information to determine a movement distance of the portable electronic device 1, and further derives a movement speed of the portable electronic device 1 from the movement speed.

The generating unit 3 is communicatively coupled to the GPS receiver 2, and generates a virtual item on the basis of the location information obtained by the GPS receiver 2. In the first preferred embodiment, the generating unit 3 is disposed in a remote server 30, receives the location information from the GPS receiver 2 using, for example, the GSM (Global System for Mobile communications) standard or the GPRS (General Packet Radio Service) standard, and generates the virtual item on the basis of the received location information. Through such a configuration, the generating unit 3 may control the generation of virtual items for a plurality of users, ensuring that the same standards are used in generating the virtual item for each user. However, in other embodiments, the generating unit 3 may be disposed in the portable electronic device 1, such as in the embodiment shown in FIG. 2 (to be described below).

The virtual item generated by the generating unit 3 may be in-game money, a play-enhancement item, experience points, a player-enhancing power, or in-game food. When the electronic game is related to a virtual pet, the virtual item generated by the generating unit 3 may be used to aid in the growth of the virtual pet, e.g., the virtual item may be in-game food.

In the first preferred embodiment, the generating unit 3 generates the virtual item on the basis of the movement distance of the portable electronic device 1 determined by the GPS receiver 2. In particular, in the first preferred embodiment, the generating unit 3 determines a weight according to the movement speed of the portable electronic device 1 derived by the GPS receiver 2, and generates the virtual item on the basis of a product of the movement distance and the weight. As an example, the weight determined by the generating unit 3 may be inversely proportional to the movement speed. In some embodiments, in order to provide a greater reward for user walking and/or jogging activity than for movement resulting from the user riding in a vehicle, the generating unit 3 gives the weight a first value if the movement speed is lower than a predetermined threshold speed, and a second value that is lower than the first value if the movement speed is greater than or equal to the predetermined threshold speed.

The processor 11 is disposed in the portable electronic device 1 and is communicatively coupled to the generating unit 3. The processor 11 performs control to enable play of the electronic game using the portable electronic device 1 by the user, and further performs control such that the virtual item may be used to enhance play of the electronic game.

In some embodiments, the processor 11 performs control to enable play of a plurality of electronic games using the portable electronic device 1 by the user. In such embodiments, one of the generating unit 3 and the processor 11 may perform control to either automatically allocate the virtual item among the plurality of the electronic games, or provide an allocating menu to allow the user to al locate the virtual item among the plurality of the electronic games.

In some embodiments, after generating the virtual item, the generating unit 3 transmits the virtual item to the storage unit 12. In this case, the processor 11 retrieves the virtual item from the storage unit 12 prior to performing control to allow the virtual item to be used to enhance play of the electronic game.

In some embodiments, the generating unit 3is disposed in a separate computer (not shown), e.g., a personal computer. In this case, the location information of the portable electronic device 1 is stored in the storage unit 12, and the generating unit 3 accesses the location information when the user connects the portable electronic device 1 to the computer, and generates the virtual item on the basis of the accessed location information.

In some embodiments, a game program(s) related to the electronic game(s) is stored in the storage unit 12. In other embodiments, such as when the electronic game is a multiplayer online game, at least a portion of a game program(s) related to the electronic game(s) is stored in the remote server 30 and at least a portion of the game program(s) is stored in the storage unit 12, in which case the processor 11 cooperates with the remote server 30 to facilitate play of the electronic game.

FIG. 2 shows a GPS-based game apparatus 100 for playing an electronic game according to a second preferred embodiment of the present invention.

In the second preferred embodiment, the generating unit 3 is disposed in the portable electronic device 1, and the portable electronic device 1 further comprises a transceiver 13. The transceiver 13 may send and receive data using a wireless or wired technology. For example, the transceiver 13 may send and receive data using the Bluetooth protocol or another radio technology, or may send and receive data via a Universal Serial Bus port. In the second preferred embodiment, the processor 11 generates an electronic coupon if a predetermined condition has been satisfied during play of the electronic game, and alerts the user of the generation of the electronic coupon, such as by performing control to display a message on the user interface of the portable electronic device 1. Moreover, in this embodiment, the processor 11 informs a physical or web-based retail outlet 40 of the generation of the electronic coupon via a communication network and through the transceiver 13.

In one embodiment, when the retail outlet 40 is a physical location, the retail outlet 40 is provided with a terminal 41. The terminal 41 includes a program that allows reading of game data in the electronic device 1. The terminal 41 accesses the game data in the portable electronic device 1 through the transceiver 13. Identification information may be included in the game data (e.g., a user code or the mobile phone number of the user), as well as game progress information. The terminal 41 is able to determine from the game data if the predetermined condition has been satisfied during play of the electronic game, such that the retail outlet 40 can allow the user to purchase a particular product at a discounted price using the electronic coupon.

When the retail outlet 40 places a limit on the use of the electronic coupon, such as the number of times that the electronic coupon may be used or a validity period of the electronic coupon, the retail outlet 40 may be further provided with a verification unit 42. The verification unit 42 checks such limitations on the use of the electronic coupon before allowing the user to use the same.

In another embodiment, when the retail outlet 40 is web-based, the retail outlet 40 may be a website that is run by a retail server and that allows retail transactions using the electronic coupon. As an example, when the user accesses the retail outlet 40 to purchase a particular product using the electronic coupon, information related to the electronic coupon may be transmitted by the portable electronic device 1 to the retail outlet 40 during the transaction (e.g., this information may be embedded in the requests sent by the user or otherwise uploaded during the transaction, such that the user may purchase the product using the electronic coupon.

In some embodiments, the generation of the electronic coupon, informing the user of the generation of the electronic coupon, and informing the retail outlet 40 of the generation of the electronic coupon are performed by one of the generation unit 3 and the remote server 30. When performed by the remote server 30, the electronic coupon may be transmitted to the retail outlet 40 (either the physical location or the retail server of the web-based retail outlet 40) by the remote server 30. In the GPS-based method and apparatus for playing an electronic game of the present invention, by using location information of the portable electronic device 1 to generate a virtual item that enhances play of the electronic game, a close association is provided between the daily activities of the user and the electronic game, such that user interest in the electronic game is maintained for a sustained period of time. Furthermore, by generating an electronic coupon that may be redeemed at a physical or web-based retail outlet depending on game progress by a user, further user interest in the electronic game is created, as are business opportunities for the retail outlet 40.

With the invention thus explained, it is apparent S that various modifications and variations can be made without departing from the spirit of the present invention. It is therefore intended that the invention be limited only as recited in the appended claims.

What is claimed is:

1. A global positioning system (GPS)-based method for playing an electronic game, the method being implemented using a game apparatus that includes a portable electronic device having a GPS receiver, said method comprising:
a) obtaining location information of the portable electronic device from a satellite signal received through the GPS receiver of the portable electronic device; and
b) generating a virtual item on the basis of the location information, the virtual item being used by a user to enhance play of the electronic game using the portable electronic device.

2. The method of claim 1, wherein the electronic game is related to a virtual pet, and the virtual item generated in step b) is used to aid in the growth of the virtual pet.

3. The method of claim 1, wherein, in step b), the virtual item is one of in-game money, a play-enhancement item, experience points, a player-enhancing power, and in-game food.

4. The method of claim 1, wherein, in step b), the virtual item is generated by one of the portable electronic device, and a remote server capable of accessing the location information of the portable electronic device.

5. The method of claim 1, a plurality of electronic games being played on the portable electronic device, said method further comprising:
c) one of automatically allocating the virtual item among the plurality of the electronic games, and providing an allocation menu to allow the user to allocate the virtual item among the plurality of the electronic games.

6. The method of claim 1, wherein, in step a), the location information is used to determine a movement distance of the portable electronic device, and in step b), the virtual item is generated on the basis of the movement distance of the portable electronic device.

7. The method of claim 6, wherein, in step a), the movement distance is used to derive a movement speed of the portable electronic device, and in step b), a weight is determined according to the movement speed of the portable electronic device, and the virtual item is generated on the basis of a product of the movement distance and the weight.

8. The method of claim 7, wherein, in step b), the weight is given a first value if the movement speed is lower than a predetermined threshold speed, and the weight is given a second value that is lower than the first value if the movement speed is not lower than the predetermined threshold speed.

9. The method of claim 7, wherein, in step b), the weight is inversely proportional to the movement speed.

10. The method of claim 1, further comprising:
c) generating an electronic coupon if a predetermined condition has been satisfied during play of the electronic game, and alerting the user of the generation of the electronic coupon; and
d) informing a retail outlet of the generation of the electronic coupon via a communication network, the retail outlet being one of a physical retail outlet and a web-based retail outlet.

11. A global positioning system (GPS)-based game apparatus for playing an electronic game, said GPS-based game apparatus comprising:
a portable electronic device for providing a user interface to allow a user to play the electronic game;
a GPS receiver disposed in said portable electronic device, said GPS receiver receiving a satellite signal and obtaining location information of said portable electronic device from the satellite signal;
a generating unit communicatively coupled to said GPS receiver for generating a virtual item on the basis of the location information; and
a processor disposed in said portable electronic device and communicatively coupled to said generating unit, said processor performing control to enable play of the electronic game using said portable electronic device by the user, and further performing control such that the virtual item may be used to enhance play of the electronic game.

12. The GPS-based game apparatus of claim 11, wherein the electronic game is related to a virtual pet, and the virtual item generated by said generating unit is used to aid in the growth of the virtual pet.

13. The GPS-based game apparatus of claim 11, wherein the virtual item generated by said generating unit is one of in-game money, a play-enhancement item, experience points, a player-enhancing power, and in-game food.

14. The GPS-based game apparatus of claim 11, wherein said generating unit is disposed in one of said portable electronic device and a remote server.

15. The GPS-based game apparatus of claim 11, wherein:
said processor performs control to enable play of a plurality of electronic games using said portable electronic device by the user; and
one of said generating unit and said processor performs control to one of automatically allocate the virtual item among the plurality of the electronic games, and provide an allocation menu to allow the user to allocate the virtual item among the plurality of the electronic games.

16. The GPS-based game apparatus of claim 11, wherein said GPS receiver uses the location information to determine a movement distance of the portable electronic device, and said generating unit generates the virtual item on the basis of the movement distance of the portable electronic device.

17. The GPS-based game apparatus of claim 16, wherein said GPS receiver uses the movement distance to derive a movement speed of the portable electronic device, and said generating unit determines a weight according to the movement speed of the portable electronic device, and generates the virtual item on the basis of a product of the movement distance and the weight.

18. The GPS-based game apparatus of claim 17, wherein said generating unit gives the weight a first value if the movement speed is lower than a predetermined threshold speed, and a second value that is lower than the first value if the movement speed is not lower than the predetermined threshold speed.

19. The GPS-based game apparatus of claim 17, wherein the weight determined by said generating unit is inversely proportional to the movement speed.

20. The GPS-based game apparatus of claim 11, wherein one of said processor, said generating unit, and a remote server:
generates an electronic coupon if a predetermined condition has been satisfied during play of the electronic game;
alerts the user of the generation of the electronic coupon; and
informs a retail outlet of the generation of the electronic coupon via a communication network, the retail outlet being one of a physical retail outlet and a web-based retail outlet.

21. A computer program product comprising a computer-readable storage medium that stores a game program for causing a game apparatus that includes a portable electronic device having a global positioning system (GPS) receiver to execute steps of a GPS-based method for playing an electronic game including:
a) obtaining location information of the portable electronic device from a satellite signal received through the GPS receiver of the portable electronic device; and
b) generating a virtual item on the basis of the location information, the virtual item being used to enhance play of the electronic game using the portable electronic device.

22. The computer program product of claim 21, wherein the electronic game is related to a virtual pet, and the virtual item generated in step b) is used to aid in the growth of the virtual pet.

23. The computer program product of claim 21, wherein, in step b), the virtual item is one of in-game money, a play-enhancement item, experience points, a player-enhancing power, and in-game food.

24. The computer program product of claim 21, wherein, in step b), the virtual item is generated by one of the portable electronic device, and a remote server capable of accessing the location information of the portable electronic device.

25. The computer program product of claim 21, a plurality of electronic games being played on the portable electronic device, said GPS-based method for playing an electronic game further including:
c) one of automatically allocating the virtual item among the plurality of the electronic games, and providing an allocation menu to allow the user to allocate the virtual item among the plurality of the electronic games.

26. The computer program product of claim 21, wherein, in step a), the location information is used to determine a movement distance of the portable electronic device, and in step b), the virtual item is generated on the basis of the movement distance of the portable electronic device.

27. The computer program product of claim 26, wherein, in step a), the movement distance is used to derive a movement speed of the portable electronic device, and in step b), a weight is determined according to the movement speed of the portable electronic device, and the virtual item is generated on the basis of a product of the movement distance and the weight.

28. The computer program product of claim 27, wherein, in step b), the weight is given a first value if the movement speed is lower than a predetermined threshold speed, and the weight is given a second value that is lower than the first value if the movement speed is not lower than the predetermined threshold speed.

29. The computer program product of claim 27, wherein, in step b), the weight is inversely proportional to the movement speed.

30. The computer program product of claim 21, wherein said GPS-based method for playing an electronic game further includes:
c) generating an electronic coupon if a predetermined condition has been satisfied during play of the electronic game, and alerting the user of the generation of the electronic coupon; and
d) informing a retail outlet of the generation of the electronic coupon via a communication network, the retail outlet being one of a physical retail outlet and a web-based retail outlet.
